(19) United States
(12) Patent Application Publication
(10) Pub. No.: US 2007/0263862 A1
(43) Pub. Date: Nov. 15, 2007

(54) MANUFACTURING PROCESS AND APPARATUS FOR PRINTING IMPRINT ON DEFECTIVE BOARD

(75) Inventors: Tzyy-Jang Tseng, Hsinchu (TW); Cheng-Po Yu, Taoyuan County (TW); Chi-Min Chang, Nantou County (TW); Cheng-Hung Yu, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: UNIMICRON TECHNOLOGY CORP., Taoyuan (TW)

(21) Appl. No.: 11/465,814

(22) Filed: Aug. 21, 2006

(30) Foreign Application Priority Data
May 9, 2006 (TW) 95116333

(51) Int. Cl. G09C 3/08

(52) U.S. Cl. 380/51

(57) ABSTRACT

A manufacturing process and an apparatus for printing imprint on defective board are provided. An automatic printing device is used for replacing operator, so as to reduce manpower and to increase the correctness and veracity of defect mark printing. The manufacturing process includes the following steps: first, an image sensor captures an image of a defect mark and transmits the image to a processing unit for data processing. Next, the data is compared, and an inkjet head is notified of the correct printing position to print ink on the customer identification mark of the printed circuit board.

### CROSS-REFERENCE TO RELATED APPLICATION

This application claims the priority benefit of Taiwan application serial no. 95116333, filed May 9, 2006. All disclosure of the Taiwan application is incorporated herein by reference.

### BACKGROUND OF THE INVENTION

1. Field of the Invention

The present invention relates to a quality control system for printed circuit board. More particularly, the present invention relates to an X-OUT process and the apparatus thereof for applying inkjet printing to printed circuit board.

2. Description of Related Art

In today's pursuit of efficiency, labor division, and QA control, ideal quality control has to be provided by raw material providers or product manufacturing and assembling factories to ensure that the reliability and quality of the products are maintained at a desired standard.

With printed circuit board as example, typical QA testing includes electrical testing, functional testing, and aging testing of open circuit and short circuit. These testing may be performed on semi-finished products during manufacturing process or on finished products to test whether a plurality of undivided sub-substrates can operate properly. When the testing shows that a particular sub-substrate on the printed circuit board has defect, first the sub-substrate having defect is marked with, for example, a X-shape symbol to indicate that this sub-substrate is a defective board. If a sub-substrate is not marked with a defect mark, the sub-substrate is usable. The product testing is generally referred to as X-OUT process in the industry.

FIG. 1 is a diagram illustrating a printed circuit board applied in conventional X-OUT process. Referring to FIG. 1, two sub-substrates 103 and 105 of the printed circuit board 100 have defects, thus, X-shape symbols are manually marked on the sub-substrates 103 and 105. Next, each sub-substrate has been previously formed with customer identification marks 111˜116 orderly arranged on the periphery of the printed circuit board 100 or around each of the sub-substrates (not shown), and the order of the customer identification marks 111˜116 are corresponding to the positions or numbers of the sub-substrates 101˜106. However, since the QC personnel has to check the numbers of the defective substrates 103 and 105 one by one and mark an obvious mark 130 on the corresponding customer identification marks 113 and 115, the process is very time-consuming and demands great manpower, accordingly the efficiency thereof can not be improved.

### SUMMARY OF THE INVENTION

Accordingly, the present invention is directed a process for printing imprint on defective board and the apparatus thereof, wherein automatic inkjet printing technology is adopted to replace operators, so as to reduce manpower and increase the correctness and veracity of defect mark printing.

The present invention provides a process for printing an imprint on defective board, and the defective board has a defect mark indicating that the defective board has at least one quality defect, and a customer identification mark to be inspected by customers. The process for printing mark on defective board includes the following steps: reading an image of the defect mark; outputting an imprint representing the defect mark through an inkjet head and forming the imprint on the customer identification mark.

According to an embodiment of the present invention, the image of the defect mark includes the data obtained by an image sensor through capturing the image of the defect mark.

According to an embodiment of the present invention, after reading the image of the defect mark, the image of the defect mark is further converted into computer readable signals. Next, a database is further compared, wherein the database is used for comparing the position, number or block pattern of the defective board to find out the position, number, or block pattern of the corresponding customer identification mark. Next, the inkjet head is notified to print the customer identification mark at the corresponding position according to the comparison result to form the imprint.

The present invention provides an apparatus for printing an imprint on defective board, wherein the defective board has a defect mark indicating that the defective board has at least one quality defect, and a customer identification mark for customers to inspect. The defect mark printing apparatus includes a processing unit for reading an image of the defect mark and an inkjet printing device connected to the processing unit, wherein the inkjet printing device has a inkjet head for outputting an imprint representing the defect mark and forming the imprint on the customer identification mark.

According to an embodiment of the present invention, the foregoing processing unit includes an image sensor for capturing an image of the defect mark and a processor connected to the image sensor for converting the image of the defect mark into computer readable signals.

According to an embodiment of the present invention, the foregoing processor includes a database for comparing the position, number, or block pattern of the defective board to find out the position, number, or block pattern of the corresponding customer identification mark.

According to an embodiment of the present invention, the foregoing inkjet printing device further includes a driving unit connected to the inkjet head for driving the inkjet head to print on the customer identification mark.

According to the present invention, inkjet printing is adopted for performing single-dot or multiple-dot printing to form imprints on customer identification marks for customers to inspect. Compared to conventional manual operation, the present invention can increase both the efficiency and the accuracy of defective board mark printing, and the printing can be performed precisely according to the pattern and size input by the user.

In order to make the aforementioned and other objects, features and advantages of the present invention comprehensible, a preferred embodiment accompanied with figures is described in detail below.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram illustrating a printed circuit board applied in conventional X-OUT process.

FIGS. 2A˜2C illustrate the steps of the manufacturing process for printing an imprint on defective board according to an embodiment of the present invention.

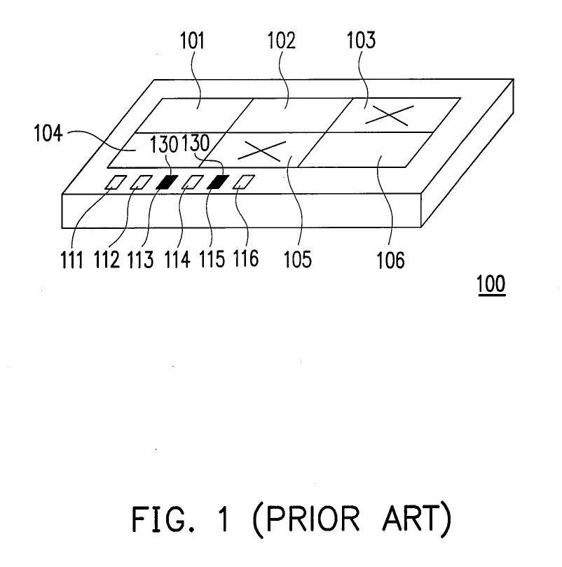

### DESCRIPTION OF EMBODIMENTS

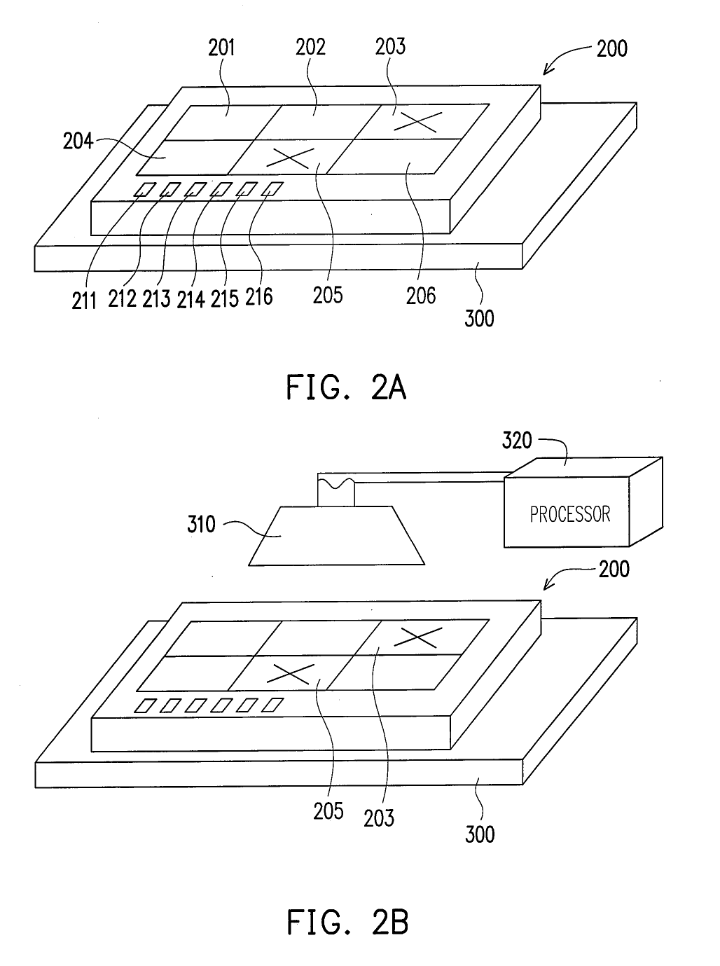

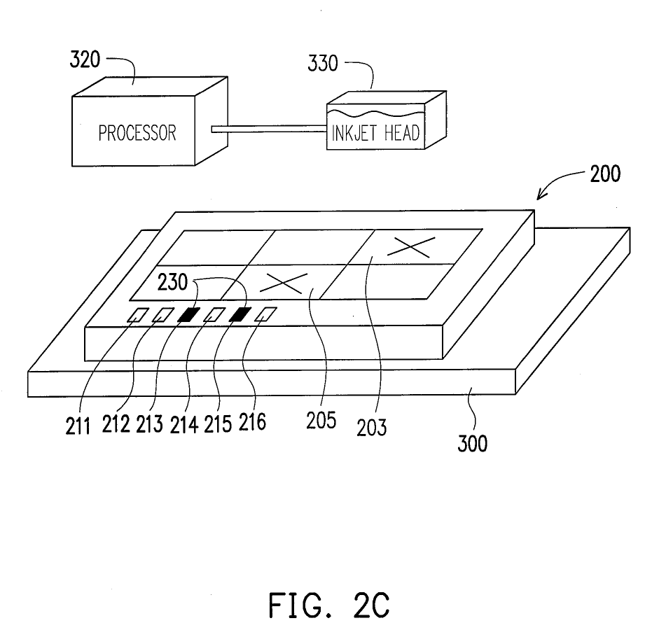

FIGS. 2A˜2C illustrate the steps of the manufacturing process for printing an imprint on defective board according to an embodiment of the present invention. First, in step 1 as shown in FIG. 2A, the printed circuit board 200, which has been QA tested, is placed on a platform 300, wherein the printed circuit board 200 has a plurality of sub-substrates 201˜206 and a plurality of corresponding customer identification marks 211˜216. For example, two sub-substrates 203 and 205 are determined to be defective, and defect marks (for example, X-shape symbols) are manually or automatically marked on the sub-substrates 203 and 205 to perform the following process. Next, in step 2 as shown in FIG. 2B, an image sensor (for example, a CCD sensor) 310 is aligned with the printed circuit board 200 to capture images of the defect marks. The images containing defect marks are sent to a processor 320 to be computerized and analyzed. After image analysis, the position, number, and block of each of the defect marks of the defective board 203 and 205 are obtained, and meanwhile, the relative information may also be obtained from a database built in the processor 320 for comparing and determining the positions, numbers, or blocks of the corresponding customer identification marks to perform subsequent inkjet printing.

Finally, in step 3 as shown in FIG. 2C, the processor 320 notifies the inkjet head 330 of the position of the inkjet printing, and then a driving unit (not shown) drives the inkjet head 330 to print onto the correct position, so that the inkjet head 330 outputs an imprint (for example, ink) 230 representing the defect marks and forms the imprint on the customer identification marks 213 and 215 of the defective boards 203 and 205 for customers to inspect. The imprint can be adjusted according to the shape input by the operator or the format and size required by the customer, and since the inkjet head prints in high speed, single-dot or multiple-dot printing can be performed. Compared to conventional manual method, the present invention increases both the efficiency and the accuracy of defective board mark printing considerably.

In the three steps described above, after the image sensor has captured the image, it transmits the image to the processing unit for data processing, so as to convert the image into computer readable signals, and then after data comparison, the inkjet head is informed of the correct position to print ink onto the customer identification mark of the printed circuit board. If the printed circuit board is placed on a moving platform, images can be captured in sequence through scanning, and then the printed circuit board is transmitted by the moving platform to be under the inkjet printing device to perform inkjet printing. The series of operations can be operated by a single operator, or can even be managed automatically to reduce manpower.

In summary, the process and apparatus for printing marks on defective board have following advantages. (1) Computerized process is performed by reading an image of the defect mark.

(2) Ink is printed onto printed circuit board through inkjet printing to increase efficiency and accuracy.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A process for printing imprint on defective board having a defect mark indicative of at least one quality defect and a customer identification mark for customers to inspect, the process comprising:
reading an image of the defect mark; and
printing an imprint representing the defect mark on the customer identification mark using an inkjet head.

2. The process as claimed in claim 1, wherein the image of the defect mark comprises a data obtained by an image sensor through capturing an image of the defect mark.

3. The process as claimed in claim 1, further comprising a step of converting the image of the defect mark into computer readable signals after the step of reading the image of the defect mark.

4. The process as claimed in claim 3, further comprising a step of comparing a position, number, or block of the defective board in a database for determining a position, number, or block of the corresponding customer identification mark after the step of converting the image of the defect mark into computer readable signals.

5. The process as claimed in claim 4, further comprising a step of notifying the inkjet head to print onto the customer identification mark according to the comparison result to form the imprint.

6. The process as claimed in claim 1, wherein the imprint comprises ink.

7. The process as claimed in claim 1, wherein the defect mark comprises X-shape symbol.

8. An apparatus for printing imprint on defective board having a defect mark indicative of at least one quality defect and a customer identification mark for customers to inspect, the defective board mark printing apparatus comprising:
a processing unit, for reading an image of the defect mark; and
an inkjet printing device, connected to the processing unit, having an inkjet head for outputting an imprint representing the defect mark and forming the imprint on the customer identification mark.

9. The apparatus as claimed in claim 8, wherein the processing unit comprises:
an image sensor, for capturing an image of the defect mark; and
a processor, connected to the image sensor for converting the image of the defect mark into computer readable signals.

10. The apparatus as claimed in claim 9, wherein the processor comprises a database for comparing a position, number, or block of the defective board to determine a position, number, or block of the corresponding customer identification mark.

11. The apparatus as claimed in claim 8, wherein the inkjet printing device further comprises a driving unit connected to the inkjet head for driving the inkjet head to print on the customer identification mark.

12. The apparatus as claimed in claim 8, wherein the imprint comprises ink.

13. The apparatus as claimed in claim 8, wherein the defect mark comprises X-shape symbol.
